(19) United States
(12) Patent Application Publication
(10) Pub. No.: US 2011/0022546 A1
(43) Pub. Date: Jan. 27, 2011

(54) COUPON METHOD AND RELATED ARTICLES FOR PROMOTING LENDING AND REFERRAL LOYALTY

(76) Inventor: Clint PAPESCH, Moreland Hills, OH (US)

Correspondence Address: EDWIN A. SISSON , ATTORNEY AT LAW , LLC, P.O. BOX 603, SHARON CENTER, OH, 44274-0603, US

(21) Appl. No.: 12/840,005

(22) Filed: Jul. 20, 2010

Related U.S. Application Data
(60) Provisional application No. 61/227,985, filed on Jul. 23, 2009.

(51) Int. Cl. G06Q 90/00

(52) U.S. Cl. 705/500

(57) ABSTRACT

This specification discloses a method and article of manufacture transformed during the method to help keep Lenders maintain the financial relationship with the Buyer after the Buyer has left the Lender's contact. The method disclosed is based upon a Lender issuing a coupon to Buyer to take to a Seller, the coupon indicating to the Seller that the Buyer has at least inquired about a loan and may even be pre-approved for a loan to buy goods from the Seller. After the Buyer inspects the Seller's goods, and hopefully purchases the goods with funds from the Lender, the coupon is then validated and redeemed to the Buyer. The Buyer receives a redemption item corresponding to the level of the transaction with the highest redemption value corresponding to purchasing the goods from the Seller with funds by the Lender.

### PRIORITY AND CROSS REFERENCES

This application claims priority from U.S. Provisional Application No. 61/227,985, filed 23 Jul. 2009, the teachings of which are incorporated in their entirety.

### FIELD OF INVENTION

This invention is to the use of coupons to improve loyalty between a Lender, Buyer and Seller.

### BACKGROUND

When buying a vehicle from an Automobile Dealer, known as a Seller; a Buyer often finances the purchase with funds from a Lending company or financing company, known as the Lender. The company financing the purchase makes money from the interest paid on the loan and the principal is eventually repaid. Because the automobile serves as collateral for the loan, there is less risk for the Lender.

Many Automobile Dealers have relationships with Lenders and usually steer, direct or otherwise encourage the Buyer to borrow money from the preferred Lender. Thus, when a Lender pre-approves a Buyer for funds, there is no guarantee that when the purchase is made, the Buyer will borrow the money from the Lender to finance the purchase.

There exists therefore the need for system which incentivizes a Buyer to borrow money from a particular Lender which at the same time identifies qualified Buyers to the Seller.

### SUMMARY

Disclosed in this specification is a method of conducting business comprising a Lender, a Buyer and a Seller comprising the steps of issuing a coupon from the Lender to the Buyer, inspection of the Seller's goods by the Buyer and optional purchase of the goods with financing from the Lender, validation of the Buyer's inspection and optional purchase to a Redeeming Party, and communication to and redemption of the coupon to the Buyer by the Redeeming Party.

It is further disclosed that the coupon also comprise a first redemption choice correlating to a first level of remuneration corresponding to the Buyer's inspection and a way to indicate selection of the first redemption choice, a unique identification of the Buyer, a unique indication of the Lender, a unique identification of the Seller. It is also further disclosed that the coupon further comprises a second redemption choice correlating to a second level of remuneration corresponding to the Buyer's purchase of the goods with a loan from the Lender and a way to indicate selection of the second redemption choice and the second level of remuneration is greater than the first level of remuneration.

It is also disclosed that the coupon may have only one redemption level.

Usually the redemption will be done by the Seller communicating the contents of the coupon to the Redeeming Party with the Redeeming party sending the redemption item(s) to the Buyer. It is also disclosed that the Redeeming Party could be the Lender or Seller.

It is also disclosed that the Lender may be a bank or credit union and the Buyer may be a customer of the respective bank or credit union member. It is also disclosed that the Seller can be a registered Automobile Dealer. Because the method involves a large purchase, it is further disclosed that the Lender's loan is secured by the goods purchased from the Seller.

It is also disclosed that the coupon indicate that it is not valid beyond a fixed date.

Also disclosed is a coupon comprising a first redemption choice correlated to a first level of redemption corresponding to a third party's inspection of a second party's goods and a means of indicating a selection of the first redemption choice, a location for the unique identification of the third party, a unique indication of the second party and a unique identification of a third party.

It is further disclosed that the coupon having a location for the indication of the of a first party, a Lender. The coupon may also have an indication location identifying a fourth party which is the redeeming party.

It is further disclosed that the coupon may comprise a communication of a second redemption choice correlated to a second level of redemption corresponding to the first party's purchase of the second party's goods using a loan from the third party and a communication means of indicating a selection of the second redemption choice.

It is further disclosed that the coupon is comprised of paper or cloth.

It is further disclosed that the coupon has a communication indicating the identification of more than one seller.

It is further disclosed that the coupon have a location for a referral indication which would is used for indicating that the third party has been pre-approved for a loan by the first party.

It is further disclosed that referral indication indicate the third party has been pre-approved for a loan by the first party.

### BRIEF DESCRIPTION OF FIGURES

FIG. 1 depicts a sample coupon of one embodiment having the elements described in the specification.

FIG. 2 depicts a coupon of another embodiment of the invention.

FIG. 3 depicts another coupon associated with an embodiment of the invention having and utilizing a pre-approval indication.

FIG. 4 depicts another coupon associated with an embodiment the invention having and utilizing an indication location for a pre-approval amount.

FIG. 5 depicts another embodiment with only one redemption option.

FIG. 6A depicts an embodiment of the coupon during the initial steps of carrying out the method.

FIG. 6B depicts the embodiment of 6A as the coupon passes to other steps of the method indicating how the coupon has been transformed during the various steps of the method.

FIG. 6C depicts the embodiment of 6A and 6B immediately prior to being redeemed.

### DESCRIPTION

The method and article disclosed in this specification is a method for a Lender (the first party), a Seller (the second party), and a Buyer (the third party) to incentivize the Buyer to purchase one or more items or goods from the Seller using funds provided by the Lender. While this method will work for almost any item which is purchased via credit, it is particularly useful for a secured transaction where the purchased item or goods serves as the security or collateral for the funds borrowed from the Lender.

One transaction suited for this method and disclosed article is the purchase of an automobile by a member of a credit union from an Automobile Dealer using funds provided by the credit union. A credit union is generally a non-profit member owned cooperative.

The first party to the transaction is the Lender. The Lender is usually an entity which provides money for the purchase of items. A typical Lender can be selected from the group consisting of banks, credit unions, savings and loans, and credit card companies. Another class of Lenders are those which take a security interest in the good as collateral for the loan. Lenders which take a security interest can be selected from the group consisting of banks, credit unions, savings and loans, and finance companies. Credit card companies are not a member of this group as they do not take a security interest in the good.

While the Lender is often a company in the financial sector, the Lender can be an individual person as well. Included in the term Lender are those individuals acting on behalf of the Lender, such as an employee, agent or representative or someone authorized by the Lender to conduct the act involved. The Lender loans money for the purchase of goods, called a loan; which is also known as financing the purchase of an item or goods.

The Lender typically checks the credit worthiness of the Buyer. The credit worthiness determines how much money and at what terms the Lender is willing to loan money to the Buyer. If the Lender is willing to loan money to the Buyer, the Buyer is at this point considered pre-approved for a loan by the Lender.

The Seller is the second party to the transaction. The Seller is an individual or legal entity which has physical goods to be purchased or for sale which can optionally be purchased with financing from the Lender. For example, a home mortgage used to purchase a house typically cannot be used to purchase an automobile. While a home equity loan can produce funds to purchase a car, the home equity loan is secured by the home and not the item being purchased.

In the case of automobiles, typical Sellers can be selected from the group consisting of registered and unregistered Automobile Dealers.

The Buyer is the third party in this transaction and is an individual or legal entity which has the ability to inspect goods, borrow money and purchase goods, for example, an automobile. In this specification the term inspect goods and purchase goods does not mean that the inspection and purchase of goods is the inspection or purchase of all of the members of the group of goods offered by a Seller. The inspection of goods could be the inspection of one fungible item and the purchase of goods could be the purchase of a single item.

One step of the process is for the Lender to issue a coupon, usually to the Buyer. The coupon can be a piece of paper, a digital disc, or other form of fixed media, including allocation of memory in a computer. If the coupon is not an allocation of memory, it is generally a physical coupon. It is at the Lender's discretion as to whether the Buyer is approved for an amount of funds and the amount for which the Buyer is approved.

The coupon performs a critical component of the method. The coupon can be a physical object with communication(s) on it. The communications are readable and understood by at least the Seller. This means that the communications could be readable by a human, by a machine, machine code, bar code, or other device which can convert the communication on the coupon to something understandable by a human being.

Consistent with the Figures, the communications will generally indicate the identity of the Lender. The identity of the Lender does not have to be the name of the Lender or even identifiable to a party not involved in the transaction. Usually the indication of the Lender is unique so that at least the Seller can identify the Lender. However, typically, the coupon will communicate the actual name of the Lender. Usually the communication is in writing or script/typed form.

The coupon will also have a communication location for the identity of the Buyer. While typically it will be the Buyer's name, it could be the Buyer's social security number, employment identification number, account number with the Lender, or even a unique symbol or mark which associates the Buyer to the Lender or Seller. At some point during the process, the Buyer's unique identification is placed upon the coupon. It could be done by the Buyer, Seller, Lender, or even someone else. Typically the Buyer's identification is placed upon the coupon and transforms the coupon to have the Buyer's identification on it when the Lender issues the coupon to the Buyer. However, it could be placed upon the coupon by the Seller or someone else prior to redemption of the coupon.

The coupon will also have a communication or communication indication on it which indicates the identity of the Seller. The identity of the Seller does not have to be the name of the Seller or even identifiable to a party not involved in the transaction. However, typically, it will communicate the name of the Seller. In fact, it may have many Sellers listed on the coupon from which the Buyer may purchase the item. The Seller who actually sold the goods to the Buyer is indicated after issuing the coupon to the Buyer.

The coupon preferably has a communication of a referral, or location for a referral indication. The referral indication, when completed by the Lender, will indicate to the Seller that the Buyer has at least inquired about borrowing funds at the lending institution. This creates two classes of Buyers, the random Buyer who will come to the Seller's location with the coupon without the referral indication or the referred Buyer who comes to the Seller's location with the coupon indicating a referral from the Lender. The Seller knows that the referred Buyer has already inquired about securing the funds to purchase the goods, and therefore is in a first level of a buying frame of mind.

In another embodiment, the referral indication would also indicate that the Buyer has been pre-approved for a loan by the Lender. The Seller knows that the pre-approved Buyer already has the wherewithal (financing) to purchase the goods, and additionally, knows that the Buyer is in an increased, or a second level of, buying frame of mind over someone who has just inquired about a loan.

In another embodiment, the referral indication would also communicate and indicate the amount of the loan for which the Buyer is pre-approved. This amount or indication of the amount would be placed on the coupon by the Lender or someone acting on the Lender's behalf. This would indicate to the Seller an even higher, or third level of, buying frame of mind and assist in setting the price of the goods.

The Buyer will inspect the Seller's goods, e.g. an automobile. In the case of the automobile, perhaps the Buyer test drives several cars. The inspection is generally a physical inspection but the inspection does not necessarily mean physical inspection; it could be an inquiry by the Buyer of the Seller of an electronic or physical catalog of the Seller's inventory.

The Buyer may or may not purchase the goods. Purchase of the goods is optional. At some point in time, the coupon is validated attesting to at least one, if not two events. A first event is that indeed the Buyer did inspect the goods. In most instances, this validation is done by the Seller or agent or representative of the Seller. It could be a signature, a special stamp, but it is an indication made on the coupon that the Buyer did in fact inspect the goods. Another event is that the Buyer actually purchased the goods using financing from the Lender. Again, this could be a signature, a special stamp, but is some indication made upon the coupon that goods were purchased from the Seller by the Buyer with funds from the Lender.

The coupon, now bearing the identification of the Lender (the first party), the Seller (the second party), and the Buyer (the third party); has been validated as to the Buyer having inspected the goods and optionally purchased the goods with financing from the Lender, is validated.

The validation is made and communicated to a Redeeming Party. Communicating the validation to a Redeeming Party could be as simple faxing the coupon with the minimum indications to the Redeeming Party, mailing the coupon, or otherwise communicating to the Redeeming Party that the Buyer inspected the goods and optionally purchased the goods with financing from the Lender.

The Redeeming Party then redeems the coupon by sending the appropriate redemption item(s) to the Buyer. The Redeeming Party can be an individual or legal entity and in fact could be the Lender or Seller as well.

The Redeeming Party will then communicate to either the Lender or the Buyer or both, that the Buyer has requested the redemption, the amount of the redemption selected, which would in turn indicate whether the Buyer purchased the goods with funds from the Lender. When the Redeeming Party is the Lender, the Lender inherently has the information from the coupon and can make decisions based upon that information. For instance, the Buyer may have inspected the goods and bought the car, but did not use a loan from the Lender. The Lender could follow up with the Seller to find out why.

In a further embodiment, if the Redeeming Party is not the Lender, the information on the coupon can be provided to the Lender.

Typically the coupon will have a first redemption choice which is correlated to a first level of remuneration associated or corresponding to the Buyer's inspection of the goods. For instance, the Buyer may receive a $20 dollar gas card for inspecting the goods. There could also be several first redemption options. For instance, after inspection the Buyer could select from a list of items, e.g. a $20 dollar gas card, an oil change, a tire rotation, or $10 dollars cash.

Typically, this first level of remuneration is part of a flat fee that the Dealer and/or Seller pays the Redeeming Party for their respective participation in the program. If the Dealer is the Redeeming Party, the Dealer would usually pay the redemption amount or item directly to the Buyer. If the Lender is the Redeeming Party, the Lender would usually pay the redemption amount or item directly to the

The coupon may also further comprise a second redemption choice correlating to a second level of remuneration corresponding to the Buyer's purchase of the goods with funds or financing from the Lender and a way to indicate selection of the second redemption choice and the second level of remuneration is greater than the first level of remuneration. If the first redemption choice has a value of $25 dollars, then it is preferred that the second redemption choice would have a value greater than $25 dollars. In fact, it is preferred that the ratio of the value of the second redemption choice to the value of the first redemption choice be in the range of 2:1 to 100:1, more preferably, 2:1 to 50:1, or even more preferably 2:1 to 10:1. The coupon could have several second redemption options for the second redemption choice.

In another embodiment, there is only one level of remuneration but which acts the same as the second redemption choice. The one level of remuneration corresponds to the Buyer's purchase of the goods with funds from the Lender. There may different items which can be selected by the Buyer. The one level of remuneration choice could have several redemption options as well.

By offering the Buyer a financial reward or other incentive for completing the transaction using the funds from the Lender, the Lender now has more assurance that the Buyer will borrow the money from the Lender and not be re-directed to another lending source by the Seller.

These embodiments and variations collateralize the referral of the Lender because when the coupon is redeemed, the Lender will know that the Buyer visited a Dealer. If the higher value of remuneration is selected indicating the purchase of the vehicle with a loan from the Lender, the cycle has worked. If the redeemed coupon for a referred Buyer, pre-approved Buyer with or without the pre-approved amount, does not indicate the second redemption choice, it means that the Buyer has purchased the vehicle without funds from the Lender. The Lender can then follow-up with the Seller to determine why alternate funding was used. This helps to prevent the Seller from substituting a different Lender from the initial Lender.

The Seller is incentivized as well because the Lender's referral to the Seller is predicated upon the Seller honoring the coupon referral by the Lender. Because of the increased quality of Buyer as measured by the Buyer's likelihood to purchase goods from the Seller, the Seller often pays a fee to the Lender and/or Redeeming party for participation in the method.

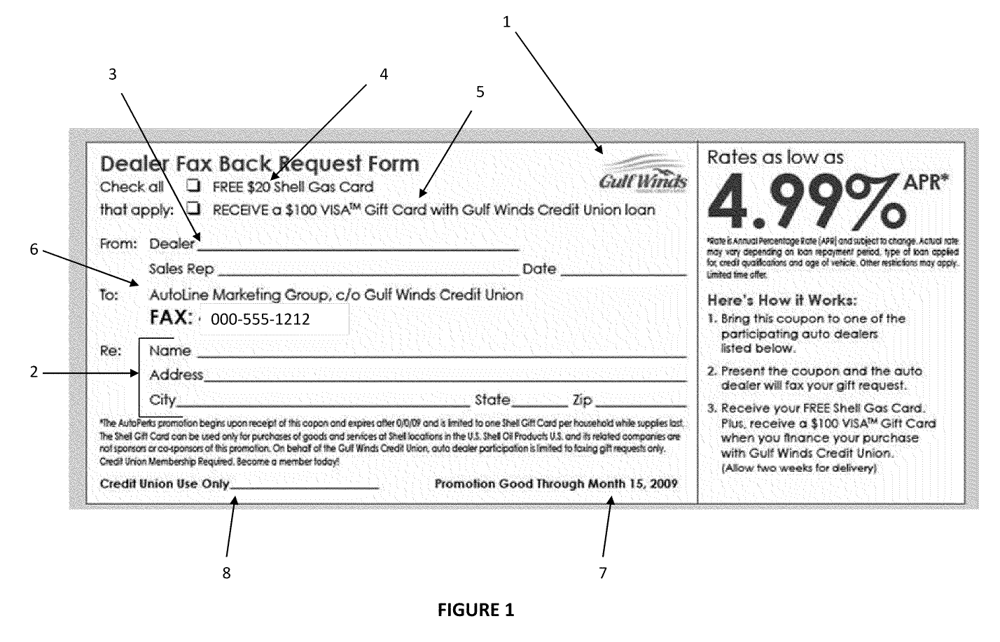

FIG. 1 is an example of a sample coupon for carrying out the transaction. Numeral 1 points to the identification of the Lender, in this instance a credit union. Numeral 2 is the space for the Buyer identification. While this example has the name, address, city, state, and zip code, the Buyer identifier could have been a unique number assigned to the Buyer as previously described. Numeral 3 is the identification of the Seller, which in this case is an Automobile Dealer. Since this coupon is not filled out, the name of Dealer chosen by the Buyer would be placed into the line numbered 3. The sales representative of the Dealer is optional. Numerals 4 and 5 are the first and second redemption choice, respectively. The ratio of the values in this instance is 5:1. Numeral 6 depicts where the Redeeming party is identified.

Note also that in this instance, the communication of the validation of the coupon to the redemption party is done via fax or facsimile. Numeral 7 is the expiration date of the coupon. Although optional, a typical promotion will have an expiration date. Numeral 8 points to the referral indicator space. Although the coupon in example says Credit Union use only, this is a typical space where the Lender places a mark indicating that the Buyer has been pre-approved for a loan. Alternatively, in more sophisticated systems, the referral indication would indicate how much the Lender is willing to loan the Buyer for the purchase.

Depending upon the referral program desired, the coupon will also contain a list of Sellers, such as Auto Dealers, who have agreed to, or even paid the Lender a fee, to participate in the couponing loyalty program.

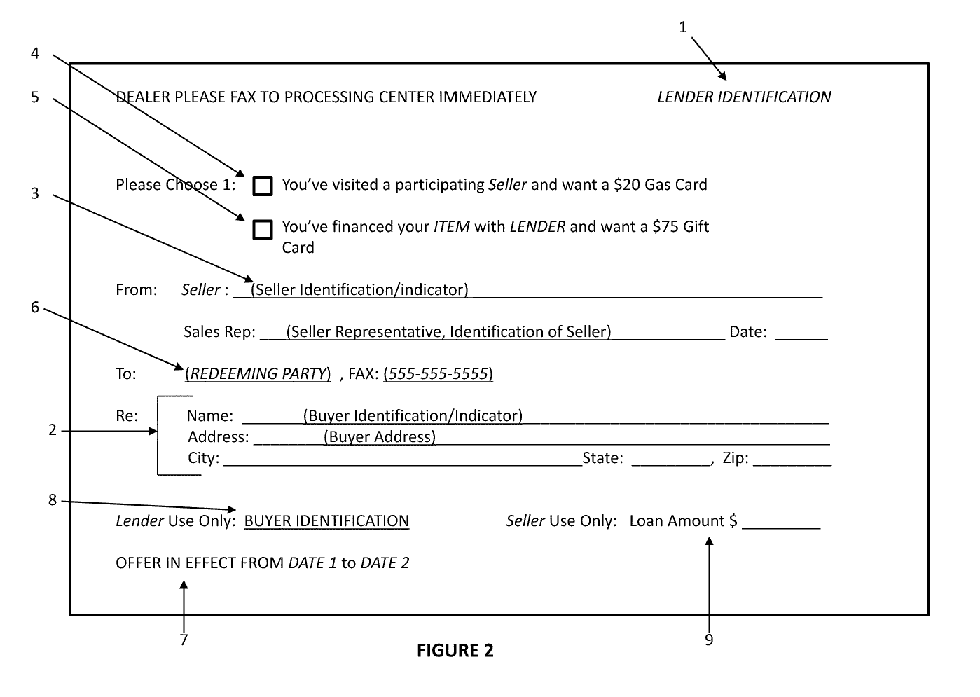

FIG. 2 is a more generic embodiment of the coupon used in the method. The italicized words are usually pre-printed on the coupon with the italics indicating that the word could be changed to reflect the type of Seller of Lender. For example, if the Seller was an Automotive Dealer, the italized word Seller could be Dealer as in FIG. 1. The italicized word “ITEM”, could be replaced with the goods being purchases, such as car.

Numeral 1 points to the Lender identification or Lender indication. This could be the name of the Lender, the Lender's logo, or any other mechanism used to identify the Lender to the Seller. As in FIG. 1, this italicized word could be the name of the Lender or the Lender's Logo or Trademark.

Numeral 2 is the location section for the identification or indication of the Buyer. In this instance, the Buyer's indication includes the Buyer's name, the Buyer's address, the Buyer's city, state and zip code.

Numeral 3 points to the Seller identification location or Seller indicator location, which is the location upon which the identification of the Seller is placed upon the coupon. Also included as an optional part of the Seller's indicator or identification is the name of the Seller's representative. The date is optional, but is desired if the parties want to ensure that the transaction was conducted during the promotion period indicated on the coupon.

Numerals 4 and 5 point to the two redemption choices, respectively, corresponding to the level of redemption earned. 4 corresponds to the visiting of the Dealer/Seller and likely inspection of the goods. 5 corresponds to purchasing an item, in this instance, and automobile, from the Seller/Dealer with funds from the Lender. Note that the actual coupon would usually have the name of the Lender where the italicized LENDER is found in the redemption choice indicated by 5. In this embodiment, the selection of the redemption option is made by the Buyer making a selection and then someone places a mark on the coupon to indicate the Buyer's choice to validate the coupon. The placement of the indicator does not necessarily have to done by the Buyer.

Numeral 6 is the indication location for the identification of the Redeeming Party. In this example, the fax number is included because the completed coupon is redeemed by faxing the coupon to the Redeeming Party. It contemplated that the validated completed coupon could be scanned and emailed or even physically mailed to the Redeeming Party. Any technique of communicating the contents of the coupon to the Redeeming Party is part of the method.

Numeral 7 points to the location where the duration or expiration of the promotion is indicated. In this embodiment, the offer is in effect from DATE 1 to DATE 2. The DATE 1 and DATE 2 would be replaced with the respective date.

Numeral 8 points to the location where the Lender can make special notes about the Buyer, for instance, the Buyer could be a member of the Lender and the Buyer member or account number could be placed here. Also, the placement of a pre-approval indication could be marked on the coupon here. The referral indication could also be placed at this mark.

This coupon contains an additional element, 9. This embodiment has a location for the Seller to indicate the amount of the loan.

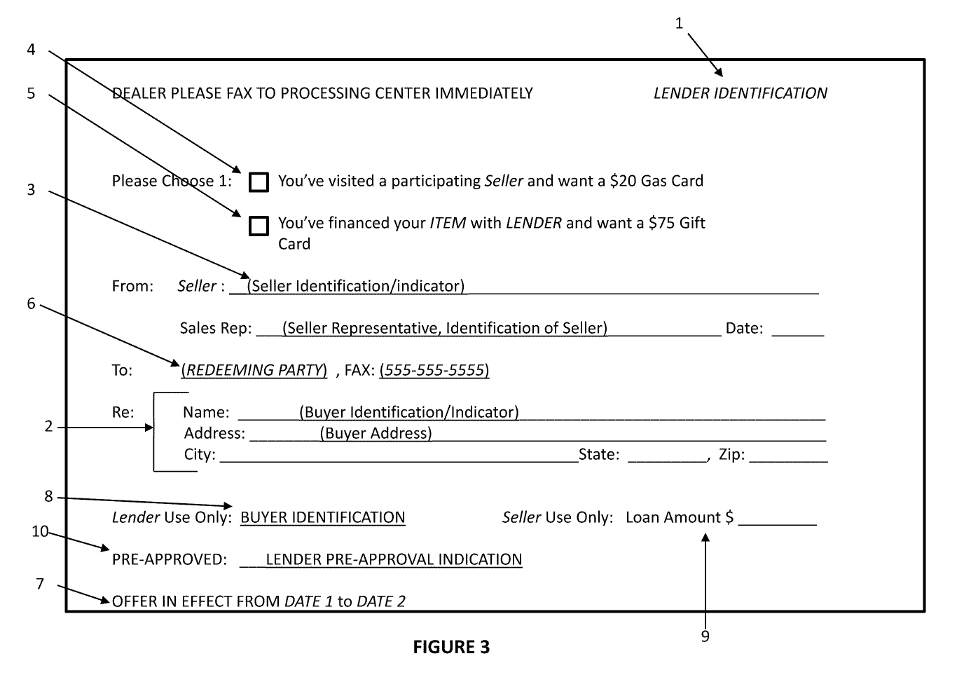

FIG. 3 is another embodiment, having the elements of FIG. 2, but with additional element 10, which has a location for the pre-approval indication of the Lender that the Buyer has been pre-approved for a loan.

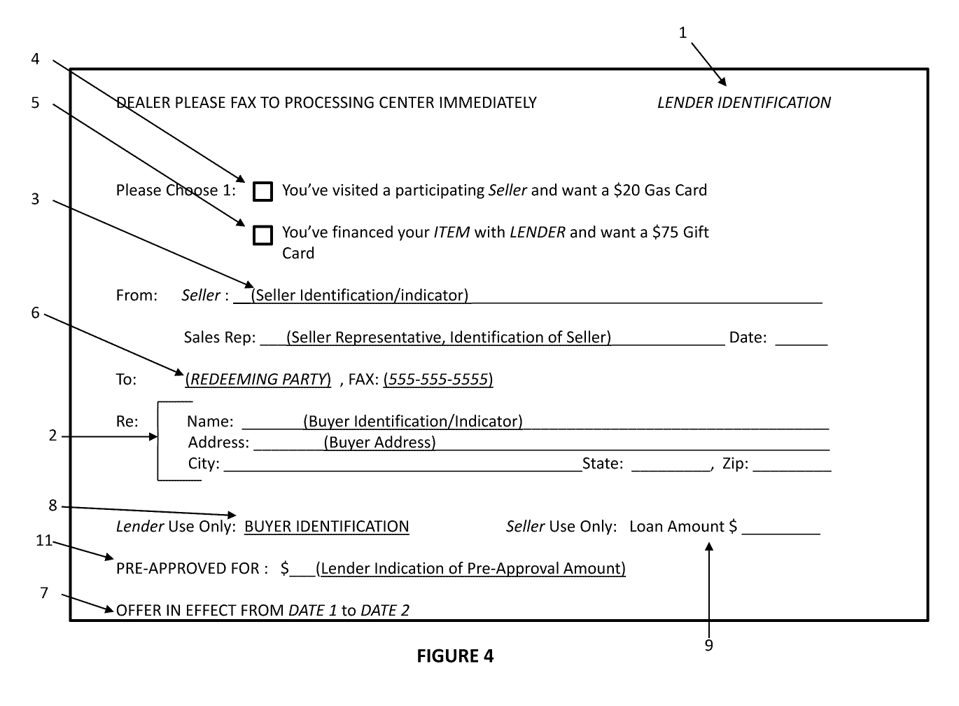

FIG. 4, has the same elements as FIG. 3, except for numeral 11, which has replaced numeral 10. Numeral 11 is the location indicated by the underline area for the Lender to indicate the amount for which Buyer has been pre-approved. Inherent in indicating a pre-approval amount, is that the Buyer is pre-approved for a loan, so a pre-approval amount is both the pre-approval indication and the indication of the amount.

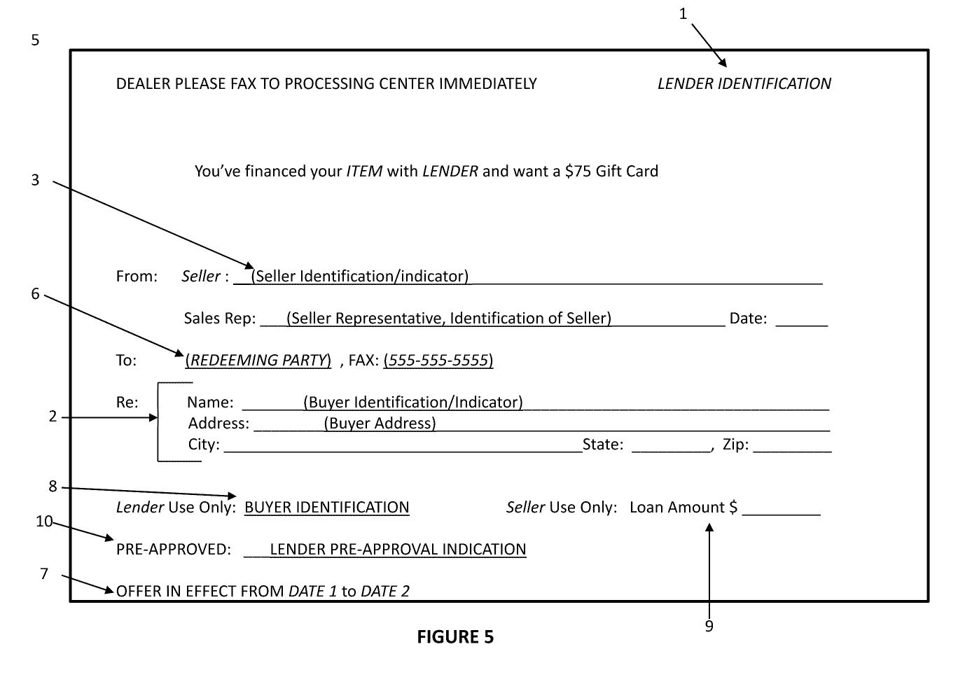

FIG. 5, has the same elements as FIG. 3, except that there is only redemption item, indicated by 5. In this embodiment, the Buyer only receives the redemption item if he or she purchases the goods, an automobile, for example, from the Seller, using the funds from the Lender. In this instance, the Lender only incentivizes the Buyer to use the funds from the Lender. There is no redemption for merely inspecting the Seller's goods.

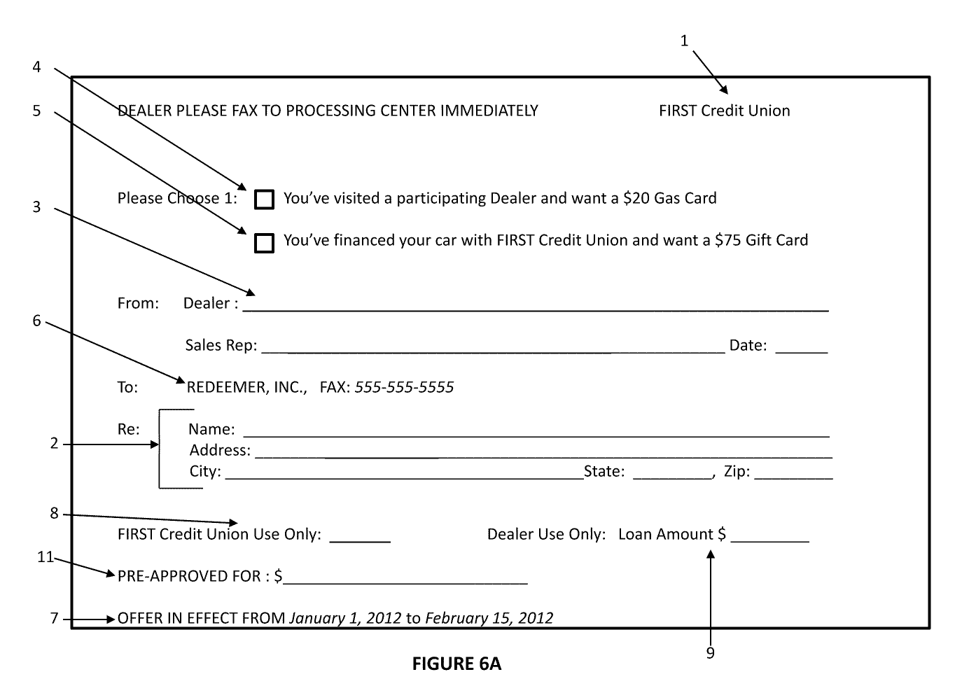

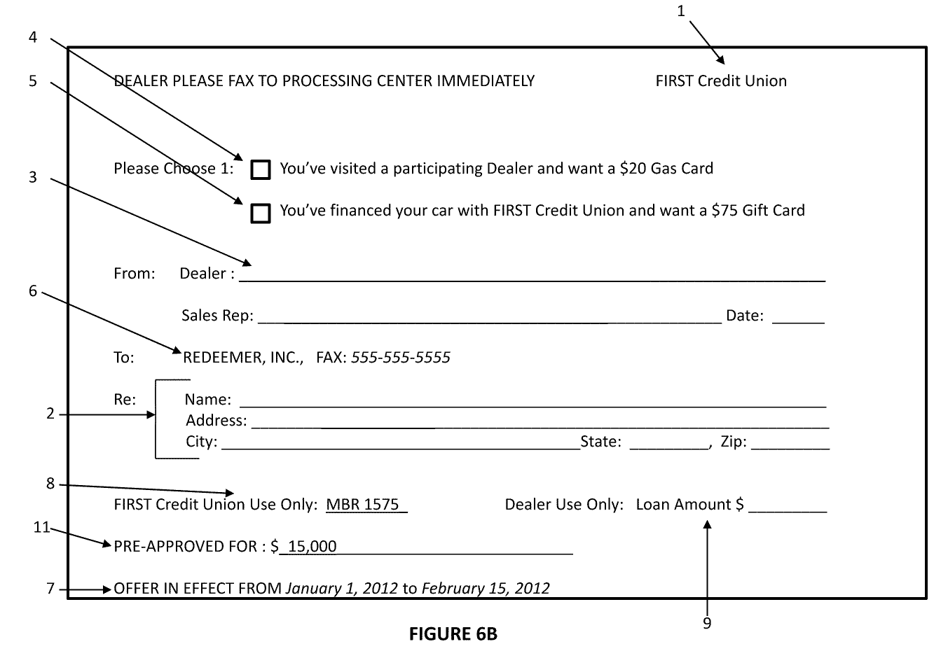

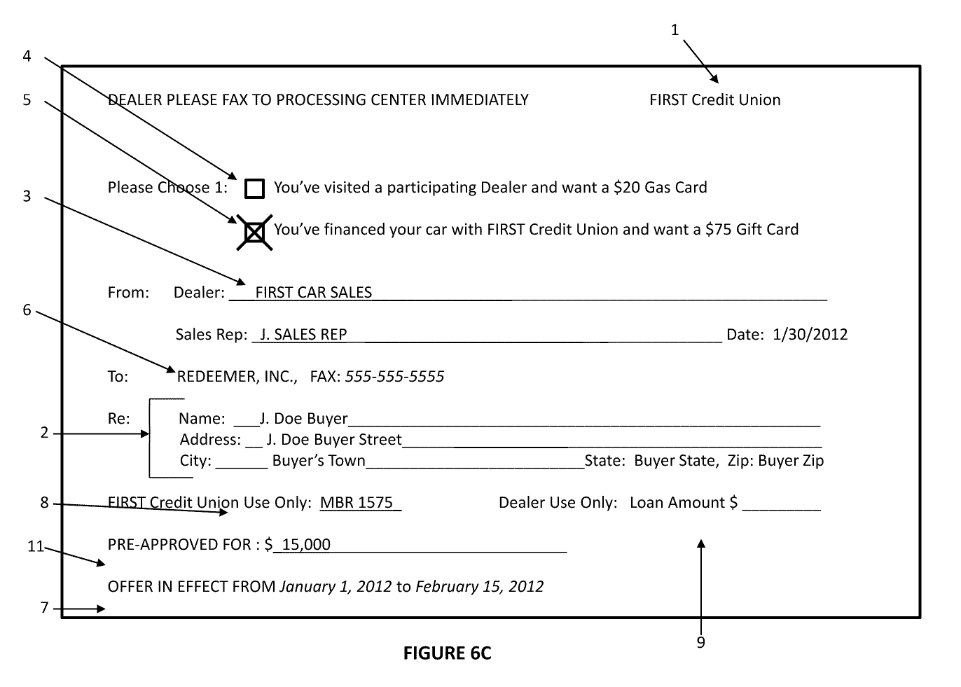

FIGS. 6A, 6B, and 6C demonstrate how the coupon is modified or transformed during the practice of the method.

FIG. 6A is the coupon as it is would be designed prior to being presented to the Buyer or transferred to the Buyer. In this instance, the Lender is called FIRST Credit Union as indicated by numeral 1, numeral 5, and numeral 8. Because this is an automobile promotion with Automobile Dealers who have agreed with the Lender and Redeemer to honor the program, the italicized word Seller at numerals 3, 4 and 9, have been changed Dealer.

In this working Example, the Redeeming Party, as pointed to by numeral 6, is REDEEMER, INC., having a facsimile number of 555-555-5555.

The promotion date is valid from Jan. 1, 2012 to Feb. 15, 2012 as indicated at numeral 7.

The paper coupon as shown in FIG. 6A could be printed out from a computer, from the internet, or pre-printed on a sheet of paper. In the preferred embodiment, the coupon is a physical sheet of paper having the elements printed out as shown.

The coupon is then modified by having the pre-approval amount, in this case $15,000 placed on the pre-approval amount indication line. This transformation of the coupon could be done the Lender, the Buyer, or other entity. Generally, the pre-approval amount will be placed on the coupon by the Lender. However, in one embodiment the Buyer has inquired of the Lender on the phone, printed out the coupon at home from the internet, and written the pre-approval amount supplied by the Lender on the coupon.

This particular coupon has also been modified at numeral 8 to indicate that the Buyer is credit union member having a number 1575. Again, this could be the Lender or Buyer or other entity.

The coupon is then transformed with additional elements of the Buyer's identification information. In this instance, the Buyer is J. Doe Buyer, living at J. Doe Buyer Street, Buyer's Town, Buyer St, Buyer zip. This information is the placed onto the coupon. Again, the information could be placed by the Lender upon giving the Buyer the coupon, the Buyer at any time during the transaction, or the Seller, or other entity. The date could also be entered into a printable file, such as a form-fillable PDF and the printed out as a physical coupon.

After the Buyer has inspected the goods and purchased the vehicle, validated completed coupon will appear as shown in FIG. 6C. In this instance, the Dealer is FIRST CAR SALES (Numeral 3), the sales rep was J. SALES REP and the date of the transaction was Jan. 30, 2012, within the promotion date. Since in the case, the Buyer purchased a vehicle with funds from FIRST Credit Union, the Buyer's indication of the $75 gift card is marked on the coupon. The indication does not need to be an X, but in some manner which indicates the choice and validates the Buyer's actions (e.g. inspection, purchase) and choices.

The information on the completed coupon is then transferred/communicated to the Redeeming Party. In this coupon, the preferred method is to fax a copy of the coupon to the Redeeming Party, which will then, this instance, send the $75 gift card to the Buyer.

That this method can be easily adapted to a computer or electronic system should be readily apparent to one of ordinary skill. One embodiment of the electronic reduction to practice would be for the coupon to reside in the memory or on the hard drive of a computer or server which can be accessed. An example of this is a form finable PDF file which allows the person accessing the file to enter data into the appropriate fields. The coupon is issued to the Buyer when the Buyer is granted access or knows that there is access to the coupon or computer file. The Lender or Buyer or Seller could enter the Buyer's information into the computer file. The Lender could grant access to different files corresponding to the level of pre-approval as well. The Lender could also place the pre-approval amount into the file. Upon completion of the inspection of the goods and optional purchase with funding from the Lender, the Seller could open the file and enter the appropriate validation code. The validated completed file, or electronic coupon, could then be sent to the Redeeming party.

It should be apparent to one of ordinary skill that many variations of the coupon and loyalty method exist and the claims include such variations and that the claims are not be limited to the examples cited in the Figures or in the specification.

I claim:

1. A method of conducting business comprising a lender, a buyer and a seller comprising the steps of
A. Issuing a coupon from the lender to the buyer,
B. Inspection of the seller's goods by the buyer and optional purchase of the goods by the buyer with financing from the lender,
C. Validation of the buyer's inspection and optional purchase and communication of the validation to a redeeming party, and
D. Redemption of the coupon to the buyer by the redeeming party.

2. The method of claim 1, wherein the coupon comprises a way to indicate selection of a redemption choice, wherein said redemption choice corresponds to the buyer having purchased a good from the seller with financing from the lender, a communication location for the identification of the buyer, a communication location for the identification of the lender, and a communication location for the identification of the seller.

3. The method of claim 2, wherein the coupon has no redemption choice other than the redemption choice corresponding to the buyer having purchased goods from the seller with financing from the lender.

4. The method of claim 2, wherein a communication identifying the buyer is placed on the coupon.

5. The method of claim 2, wherein the lender's financing is secured by the goods purchased by the buyer from the seller.

6. The method of claim 4, wherein the lender's financing is secured by the goods purchased by the buyer from the seller.

7. The method of claim 2, wherein the redeeming party is selected from the group consisting of the lender and the seller.

8. The method of claim 2, wherein the redeeming party is not the lender or the seller.

9. The method of claim 2, wherein the coupon has a referral indication which is used to indicate that the buyer has at least inquired about a loan from the lender.

10. The method of claim 2, wherein the coupon has a referral indication which is used to indicate that the buyer has been pre-approved for a loan by the lender.

11. A coupon comprising a communication of a first redemption choice correlated to a first level of redemption corresponding to a third party's inspection of a second party's goods which are for sale by the second party and a communication means of indicating a selection of the first redemption choice, a location for the unique identification of a first party which is a lender, a communication location for a unique indication of the second party which is a seller and a communication location for a unique identification of the third party which is a buyer.

12. The coupon of claim 11, further comprising a communication location to indicate a fourth party and the fourth party is a redeeming party.

13. The coupon of claim 11, further comprising a communication of a second redemption choice correlated to a second level of redemption corresponding to the first party's purchase of the second party's goods using a loan from the third party and a communication means of indicating a selection of the second redemption choice.

14. The coupon of claim 11, wherein the coupon is comprised of paper or cloth.

15. The coupon of claim 11, wherein the coupon has a communication indicating the identification of more than one seller.

16. The coupon of claim 11, wherein there is a space for a referral indication which would is used for indicating that the third party has been pre-approved for a loan by the first party.

17. The coupon of claim 12, wherein there is a space for a referral indication which would is used for indicating that the third party has been pre-approved for a loan by the first party.

18. The coupon of claim 13, wherein there is a space for a referral indication which would is used for indicating that the third party has been pre-approved for a loan by the first party.

19. The coupon of claim 14, wherein there is a space for a referral indication which would is used for indicating that the third party has been pre-approved for a loan by the first party.

20. The coupon of claim 15, wherein there is a space for a referral indication which would is used for indicating that the third party has been pre-approved for a loan by the first party.
